(19) United States
(12) Patent Application Publication
(10) Pub. No.: US 2013/0010673 A1
(43) Pub. Date: Jan. 10, 2013

(54) RELAY METHOD FOR INCREASING FREQUENCY SELECTIVE CHARACTERISTIC OF WIRELESS CHANNEL AND RELAY DEVICE USING SAME

(75) Inventors: Hee Soo Lee, Daejeon (KR); Tae Gyun Noh, Daejeon (KR); Jae Young Ahn, Daejeon (KR); Kyoung Seok Lee, Daejeon (KR); Min Joong Rim, Seoul (KR); Chung Gu Kang, Seoul (KR)

(73) Assignees: Dongguk University Industry-Academic Cooperation Foundation, Seoul (KR); Electronics and Telecommunications Research Institute, Daejeon (KR)

(21) Appl. No.: 13/511,749

(22) PCT Filed: Nov. 26, 2010
(86) PCT No.: PCT/KR2010/008432

§ 371 Date: Sep. 25, 2012

(30) Foreign Application Priority Data
Nov. 27, 2009 (KR) 10-2009-0116112

(51) Int. Cl. H04W 72/00; H04W 88/04

(52) U.S. Cl. 370/315

(57) ABSTRACT

A relay method of a wireless communication system according to one embodiment of the present invention relates to a relay method of a wireless communication system in which at least one relay device communicates with a base station. The relay method comprises the steps of: each relay device setting information about a frequency band to be relayed, composing a control signal including the information about the set frequency band, and transmitting the control signal to at least one relay device; and receiving the control signal, extracting the information about the frequency band included in the control signal, amplifying the signal according to the information about the frequency band set in each relay device, and transmitting the amplified signal to at least one terminal.

### TECHNICAL FIELD

The present invention relates to signal amplification technology for a repeater or relay, and more particularly, to a relay method improving a frequency selection characteristic of a wireless channel in an orthogonal frequency division multiplexing (OFDM)-based cellular mobile communication system and a relay apparatus using the relay method.

### BACKGROUND ART

A repeater or relay serves as a relay connecting a base station and user equipment (UE). The repeater or relay is installed in a shadow region, at a cell boundary, etc. with no addition of a new base station or no expansion of a wired backhaul, and has a main purpose of effectively expanding cell coverage and increasing throughput.

The repeater or relay is installed at or outside a cell coverage boundary of a base station to provide service to terminals out of a cell radius of the base station or serve terminals present across a forest of buildings from the base station, terminals present among buildings, terminals present in a building with a poor wireless environment, and terminals present in a subway train by relaying a signal of the base station.

Analog repeaters that simply amplify radio frequency (RF) power and forward the amplified result to terminals have been frequently used in a mobile communication system. The analog repeaters have advantages in that the analog repeaters can be simply implemented and have small delay, but also have a disadvantage in that noise is amplified together with a signal.

To overcome this disadvantage, a smart repeater or advanced repeater having an improved function and also relay station (RS) technology including a better function have emerged. According to data forwarding schemes, relays can be classified into a layer 1 (L1) relay based on amplify-and-forward relaying strategy, a layer 2 (L2) relay based on decode-and-forward relaying strategy, and a layer 3 (L3) relay based on self-backhauling.

Among these several types of repeaters or relays, an analog repeater which has been frequently used simply amplifies all signals received from a base station or terminal in an analog domain and retransmits the amplified signals. However, when repeaters or relays amplify all received signals while additional repeaters or relays are installed to increase cell-edge capacity, interference on an adjacent cell also increases, resulting in deterioration of system performance.

Since a repeater or relay operating in this way cannot know whether a terminal requiring signal amplification is actually present within coverage of the repeater or relay itself, selective amplification is impossible.

### DISCLOSURE

### Technical Problem

The present invention is directed to providing a relay method allowing amplification in only a specific band according to necessity to improve a frequency-selective characteristic, and a relay apparatus using the relay method.

### Technical Solution

One aspect of the present invention provides a relay method in a wireless communication system in which a base station and at least one relay apparatus communicate, the method including: setting information about a frequency band to be relayed by each relay apparatus, and configuring and transmitting a control signal including the information about the set frequency band to the at least one relay apparatus; and receiving the control signal, extracting the information about the frequency band included in the control signal, amplifying a signal according to the information about the frequency band set for the relay apparatus, and transmitting the amplified signal to at least one terminal.

The information about a frequency band relayed by each relay apparatus may be transmitted to the relay apparatus using the control signal transmitted from the base station to each relay apparatus.

The relay apparatus receiving the control signal may decode the control signal and obtain information about an amplification level and the frequency band to be amplified and transmitted according to the frequency band information included in the decoded control signal.

The frequency band relayed by each relay apparatus may be set to an initial value when the relay apparatus is installed, and dynamically changed with another frequency band.

The information about a frequency band to be relayed by each relay apparatus may include information about a pass band and a stop band to be amplified by the relay apparatus, and a higher amplification level may be set for the pass band than the stop band that is a band other than the pass band.

The information about a frequency band to be relayed by each relay apparatus may also include a ratio of a power of the pass band to a power of the stop band, and the ratio of the pass band power to the stop band power may be dynamically adjusted in consideration of load according to distribution of terminals served by the relay apparatus.

The information about a frequency band to be relayed by each relay apparatus may include information about at least one frequency band relayed by the relay apparatus and a frequency band-specific amplification level.

Another aspect of the present invention provides a wireless communication system in which a base station and at least one relay apparatus communicate, the system including: the base station configured to set information about a frequency band to be relayed by each relay apparatus, and configure and transmit a control signal including the information about the set frequency band to the at least one relay apparatus; and the at least one relay apparatus configured to receive the control signal, extract the information about the frequency band included in the control signal, amplify a signal according to the information about the frequency band set for the relay apparatus, and transmit the amplified signal to at least one terminal.

Still another aspect of the present invention provides a base station communicating with at least one relay apparatus, the base station setting information about a frequency band to be relayed by each relay apparatus and configuring and transmitting a control signal including the information about the set frequency band to the at least one relay apparatus.

The base station may allocate radio resources of the same frequency band as radio resources allocated to the relay apparatus to a terminal present near the relay apparatus.

Yet another aspect of the present invention provides a relay apparatus relaying communication between a base station and at least one terminal, the relay apparatus receiving a control signal including information about a frequency band to be relayed from the base station, extracting the information about the frequency band included in the control signal, amplifying a signal according to the information about the frequency band set for the relay apparatus, and transmitting the amplified signal to the at least one terminal.

The relay apparatus may be a smart repeater.

### Advantageous Effects

A relay method and apparatus according to an exemplary embodiment of the present invention can perform amplification for terminals only within their coverage to reduce interference in a user at a cell edge significantly interfered with by an adjacent cell, thereby increasing average capacity.

Also, when the same frequency band as the closest relay is allocated through scheduling of a base station, average capacity of users present at not only the edge but also the center of a cell can be increased.

Furthermore, an exemplary embodiment of the present invention proposes a constitution for dynamically setting a frequency domain-specific amplification ratio, which can be dynamically adapted to various system environments (user distribution, fading channel models, etc.).

### DESCRIPTION OF DRAWINGS

FIG. 1 illustrates a frequency-selective relay method according to a first exemplary embodiment of the present invention.

FIG. 2 illustrates a frequency-selective relay method according to a second exemplary embodiment of the present invention.

FIG. 3 illustrates an example of a frequency-selective relay method according to a third exemplary embodiment of the present invention.

FIG. 4 illustrates another example of the frequency-selective relay method according to the third exemplary embodiment of the present invention.

### MODES OF THE INVENTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

As used herein, the term “terminal” may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various exemplary embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

In this specification, the term “base station” used herein generally denotes a fixed point communicating with a terminal, and may be referred to as a Node-B, evolved Node-B (eNode-B), base transceiver system (BTS), access point, and other terms.

In the present invention, a relay apparatus improving a frequency-selective characteristic can operate using relay methods according to the following three exemplary embodiments.

### First Exemplary Embodiment

A method of receiving a control signal from a base station and decoding the received control signal to amplify a frequency band indicated by the control signal

### Second Exemplary Embodiment

A method of amplifying a specific frequency band which has been already defined in an initial process of installing the relay apparatus without decoding a control signal from a base station

### Third Exemplary Embodiment

A method of receiving a control signal from a base station and amplifying respective frequency bands with different degrees of amplification according to an instruction of the control signal

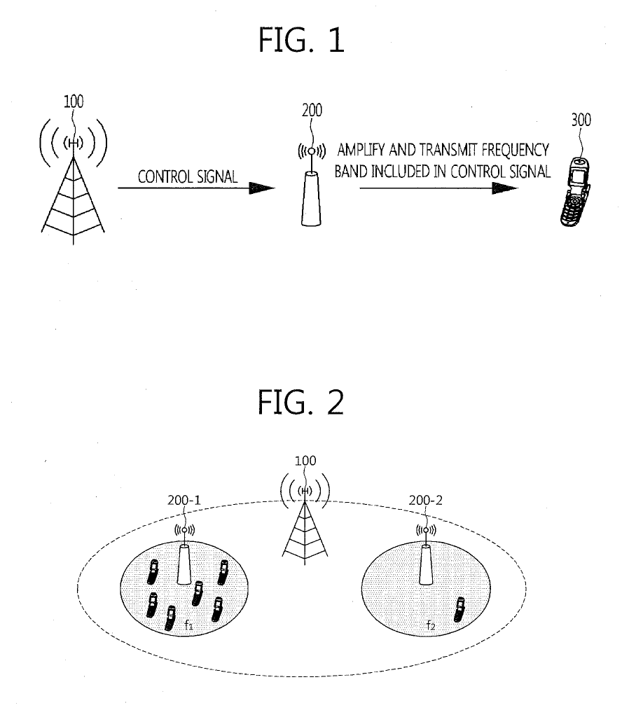

FIG. 1 illustrates a frequency-selective relay method according to a first exemplary embodiment of the present invention.

In the method according to the first exemplary embodiment of the present invention, a base station 100 transmits a control signal including information about a frequency band that a relay apparatus 200 should amplify to the relay apparatus 200. The relay apparatus 200 receives the control signal from the base station and decodes the received control signal. The relay apparatus 200 decoding the control signal amplifies the frequency band indicated by the control signal and transmits the amplified result to a terminal 300.

To this end, the relay apparatus 200 should have a function for decoding the control signal received from the base station 100. Also, the base station 100 has a function of notifying each relay apparatus of information about a band that the relay apparatus should amplify and transfer, that is, a band to be allocated to at least one terminal present in coverage of the relay apparatus.

FIG. 2 illustrates a frequency-selective relay method according to a second exemplary embodiment of the present invention.

In the second exemplary embodiment of the present invention, initial setting is performed for a relay apparatus during a process of installing the relay apparatus in a cell so that each relay apparatus can amplify a specific frequency band only.

Referring to FIG. 2, in an initial relay apparatus setting process, first and second relay apparatuses 200-1 and 200-2 have been already set to amplify f1 and f2 bands, respectively.

Thus, the relay apparatuses 200-1 and 200-2 need not and do not receive a control signal from a base station in relation to selective amplification of a frequency, and rather amplify a bandwidth set during initial setting to transmit the amplified result to a terminal.

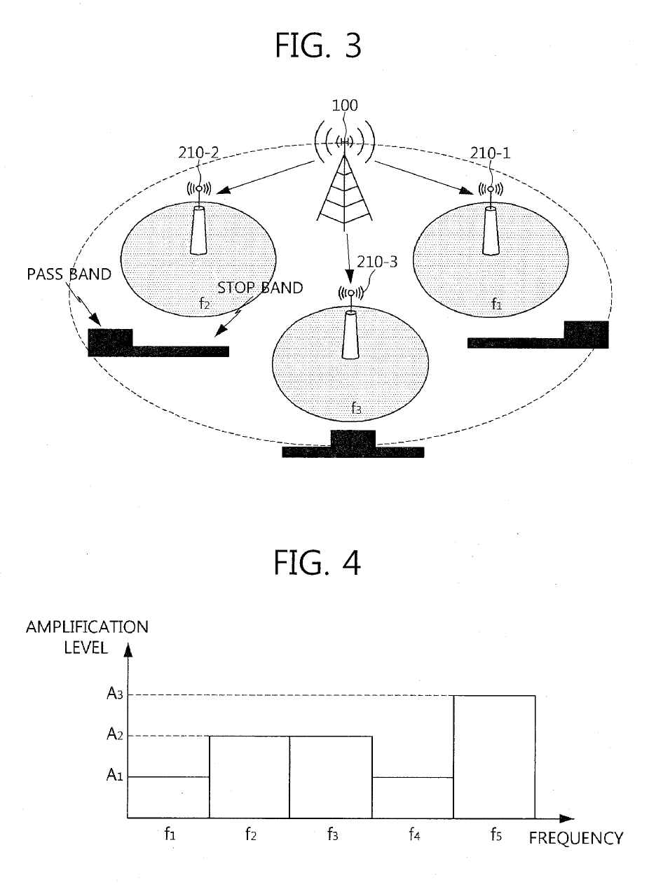

FIG. 3 illustrates an example of a frequency-selective relay method according to a third exemplary embodiment of the present invention.

In the third exemplary embodiment of the present invention, a relay apparatus amplifies a specific bandwidth (pass band) allocated to the relay apparatus itself more than other bands and transmits the amplified result. In the third exemplary embodiment of the present invention, a frequency-selective channel is artificially generated.

While a conventional repeater or relay performs amplification for a whole band using power of the same magnitude, in the third exemplary embodiment of the present invention, each relay apparatus in a cell amplifies a specific bandwidth set for the relay apparatus itself more than other bandwidths by a predetermined ratio, for example, a ratio of pass band power/stop band power.

Referring to FIG. 3, a first relay apparatus 210-1 amplifies f1 band of a whole band more than other bands, a second relay apparatus 210-2 amplifies f2 band of the whole band more than other bands, and a third relay apparatus 210-3 amplifies f3 band of the whole band more than other bands. In an exemplary embodiment of the present invention, the relay apparatuses shown in FIG. 3 are layer 1 (L1) relays, more specifically, smart repeaters among L1 relays.

Here, a relay apparatus having a ratio of pass band power/stop band power of 1 is the same as a conventional repeater or relay, and a relay apparatus having a ratio of pass band power/stop band power of greater than 1 is a relay apparatus according to the third exemplary embodiment of the present invention. Also, a ratio of “pass band power/stop band power” according to an exemplary embodiment of the present invention can be dynamically adjusted in consideration of load according to user distribution.

A position of a pass band and the ratio of “pass band power/stop band power” can be controlled to dynamically vary by signaling of a base station transferring a parameter including information about the position of a pass band and the ratio of “pass band power/stop band power.”

FIG. 4 illustrates another example of the frequency-selective relay method according to the third exemplary embodiment of the present invention.

The exemplary embodiment shown in FIG. 4 is an example of a more comprehensive concept than a pass band or stop band of the exemplary embodiment shown in FIG. 3. In other words, a base station freely sets the degree or level of amplification for each frequency band and signals information about the set degree or level of amplification to a relay apparatus.

Referring to FIG. 4 in detail, when a frequency band of a signal relayed by a relay apparatus includes f1, f2, f3, f4 and f5 bands, a base station may set an amplification level for f1 and f4 bands to A1, an amplification level for f2 and f3 bands to A2, and an amplification level for f5 band to A3, as shown in FIG. 4. The base station includes information about the band-specific amplification levels or degrees in a control signal and transmits the control signal to the relay apparatus, and the relay apparatus receives the control signal from the base station, sets the amplification levels for the respective bands, and performs signal relay.

In other words, in the exemplary embodiment of the present invention shown in FIG. 4, a frequency domain-specific amplification ratio is freely and dynamically set and can be dynamically applied to various system environments (user distribution, fading channel models, an adjacent cell interference environment varying according to time, and so on).

The exemplary embodiments of the present invention shown in FIGS. 3 and 4 have greater effect than a conventional repeater or relay particularly when a base station can perform good scheduling for a user. When the base station can allocate the same frequency band as a pass band of a relay apparatus disposed closest to a user by scheduling, a relay apparatus according to the exemplary embodiments of the present invention can amplify a signal for a user near the relay apparatus itself more than other signals and also a signal for a user allocated a frequency other than a frequency of the relay apparatus itself less than other signals, thereby reducing interference in an adjacent cell and increasing channel capacity.

Also, an area of a band amplified by a repeater or relay of a region in which many users are present is set to be large, and an area of a band amplified by a repeater or relay of a region in which few users are present is set to be small, thereby enabling handling adapted to a situation of a system.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

While the invention has been shown and described with reference to certain exemplary embodiments thereof, it will be understood by those skilled in the art that various changes in form and details may be made therein without departing from the spirit and scope of the invention as defined by the appended claims.

1. A relay method in a wireless communication system in which a base station and at least one relay apparatus communicate, the method comprising:
setting information about a frequency band to be relayed by each relay apparatus, and configuring and transmitting a control signal including the information about the set frequency band to the at least one relay apparatus; and
receiving the control signal, extracting the information about the frequency band included in the control signal, amplifying a signal according to the information about the frequency band set for the relay apparatus, and transmitting the amplified signal to at least one terminal.

2. The relay method of claim 1, wherein the information about a frequency band relayed by each relay apparatus is transmitted to the relay apparatus using the control signal transmitted from the base station to each relay apparatus.

3. The relay method of claim 2, wherein the relay apparatus receiving the control signal decodes the control signal and obtains information about an amplification level and the frequency band to be amplified and transmitted according to the information about the frequency band included in the decoded control signal.

4. The relay method of claim 1, wherein the frequency band relayed by each relay apparatus is set to an initial value when the relay apparatus is installed, and dynamically changed to another frequency band.

5. The relay method of claim 1, wherein the information about a frequency band to be relayed by each relay apparatus includes information about a pass band and a stop band to be amplified by the relay apparatus, and
a higher amplification level is set for the pass band than the stop band that is a band other than the pass band.

6. The relay method of claim 5, wherein the information about a frequency band to be relayed by each relay apparatus further includes a ratio of a power of the pass band to a power of the stop band, and
the ratio of the pass band power to the stop band power is dynamically adjusted in consideration of load according to distribution of terminals served by the relay apparatus.

7. The relay method of claim 1, wherein the information about a frequency band to be relayed by each relay apparatus includes information about at least one frequency band relayed by the relay apparatus and a frequency band-specific amplification level.

8. A wireless communication system in which a base station and at least one relay apparatus communicate, the system including:
the base station configured to set information about a frequency band to be relayed by each relay apparatus, and configure and transmit a control signal including the information about the set frequency band to the at least one relay apparatus; and
the at least one relay apparatus configured to receive the control signal, extract the information about the frequency band included in the control signal, amplify a signal according to the information about the frequency band set for the relay apparatus, and transmit the amplified signal to at least one terminal.

9. A base station communicating with at least one relay apparatus, wherein the base station sets information about a frequency band to be relayed by each relay apparatus and configures and transmits a control signal including the information about the set frequency band to the at least one relay apparatus.

10. The base station of claim 9, wherein the information about a frequency band to be relayed by each relay apparatus includes information about a pass band and a stop band to be amplified by the relay apparatus, and
a higher amplification level is set for the pass band than the stop band that is a band other than the pass band.

11. The base station of claim 10, wherein the information about a frequency band to be relayed by each relay apparatus further includes a ratio of a power of the pass band to a power of the stop band, and
the ratio of the pass band power to the stop band power is dynamically adjusted in consideration of load according to distribution of terminals served by the relay apparatus.

12. The base station of claim 9, wherein the base station allocates radio resources of the same frequency band as radio resources allocated to the relay apparatus to a terminal present near the relay apparatus.

13. The base station of claim 9, wherein the information about a frequency band to be relayed by each relay apparatus includes information about at least one frequency band relayed by the relay apparatus and a frequency band-specific amplification level.

14. A relay apparatus relaying communication between a base station and at least one terminal, wherein the relay apparatus receives a control signal including information about a frequency band to be relayed from the base station, extracts the information about the frequency band included in the control signal, amplifies a signal according to the information about the frequency band set for the relay apparatus, and transmits the amplified signal to the at least one terminal.

15. The relay apparatus of claim 14, wherein the information about a frequency band to be relayed includes information about at least one frequency band relayed by the relay apparatus and a frequency band-specific amplification level.

16. The relay apparatus of claim 14, wherein the relay apparatus is a smart repeater.
